(19) United States
(12) Patent Application Publication
(10) Pub. No.: US 2003/0043038 A1
(43) Pub. Date: Mar. 6, 2003

(54) Modulating current of an integrated circuit for signal transmission

(76) Inventors: Mansour Izadinia, Los Altos, CA (US); Francesco Rezzi, Santa Clara, CA (US); Thong Huynh, Fremont, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/947,052

(22) Filed: Sep. 5, 2001

(51) Int. Cl. G08B 13/12

(52) U.S. Cl. 340/568.2; 340/310.01; 713/100

(57) ABSTRACT

Modulating current of an integrated circuit for signal transmission. The invention may be used in a network device to signal its presence or continued presence to a network router, mid span, hub, or switch, and/or to identify its characteristics or class to control whether and/or what power is applied to the applicable network lines to fully power the network device. Use of the invention in a network environment allows use of certain lines as low voltage signal communication lines for certain network devices, and use of the same lines and/or of different lines for powering other network devices from the same lines at voltages that would damage devices intended for low voltage communication.

### BACKGROUND OF THE INVENTION

1.Field of the Invention

The present invention relates to the field of networks and signal communication devices and systems.

2. Prior Art

There are systems in which one integrated circuit needs to send simple data or a signal for some purpose to another integrated circuit in the system. For example, sometimes one integrated circuit needs to send a signal to another integrated circuit to signal its presence. In these cases, typically a data line has been required. This however increases pin count on the integrated circuits if feasible in the system under consideration, and in some circumstances, cannot be done because of a pre-commitment for the number of pins and their use defining the connectivity between the integrated circuits.

U.S. Pat. No. 5,406,260 discloses a Network security system for detecting removal of electronic equipment. In accordance with that patent, a system and method are provided for monitoring the connection of electronic equipment, such as remote computer workstations, to a network via a communication link and detecting the disconnection of such equipment from the network. The system includes current loops internally coupled to protected pieces of equipment so that each piece of associated equipment has an associated current loop. A low current power signal is provided to each of the current loops. A sensor monitors the current flow through each current loop to detect removal of the equipment from the network. Removal of a piece of hardware breaks the current flow through the associated current loop which in turn may activate an alarm. This invention is particularly adapted to be used with an existing 10BaseT communication link or equivalent thereof, employing existing wiring to form the current loops. The system uses pairs of signal lines through which no other DC current is flowing, with the low current power signal being provided by the network to the signal lines of the device connected to the network.

### BRIEF SUMMARY OF THE INVENTION

This invention relates to detection of the presence of a peripheral device on a network. There are several types of devices commonly present on a network. These devices include computers, Internet telephones, switches, Routers, hubs, Wireless Access Nodes, Web Cameras, etc. One of the issues with these devices is for a network controller to detect the presence of a particular device such as an Internet phone (IP phone) on the network. The invention is to incorporate an AC current within a peripheral device for the purposes of detecting its presence on the network at the router, mid span, or switch. This AC current will give the equipment a “heart beat” which then can be detected by other equipment, such as network controllers, routers, mid spans, switches, etc.

The reason that the network router needs to detect the presence of an IP phone is so that it could deliver proper power to the network device. Normally, devices on a network such as a 100BaseT network do not draw power from that network. The exception to this is devices such as IP phones, Wireless Access Nodes, Web Cameras, etc. These devices need power to operate. Therefore, the network switch, router, and/or mid span need to detect the presence and then the removal of such devices. This invention relates to incorporating an AC or pulsating load within these devices to enable the network switch to detect the presence and/or removal of such devices. The AC or pulsating load can be any form of pulsating load or current.

### BRIEF DESCRIPTION OF THE DRAWINGS

FIG. 1 is a diagram of an exemplary embodiment of the present invention.

### DETAILED DESCRIPTION OF THE PREFERRED EMBODIMENT

In accordance with the present invention, a signal from a first integrated circuit to another integrated circuit is provided by modulating the power supply current of and by the first integrated circuit. In particular, integrated circuits consume supply current in order to operate. This supply current is typically a DC current, which can be modulated by the integrated circuit powered by the respective supply current as a means of transmitting data to another integrated circuit. This data can signify the presence of the integrated circuit or act as a means of actually sending data from one integrated circuit to another. The alternating supply current of the integrated circuit gives the first integrated circuit a “heart beat” which can be detected by a second integrated circuit. This modulating supply current can easily be differentiated from other DC currents of the system or other modulating currents within the system.

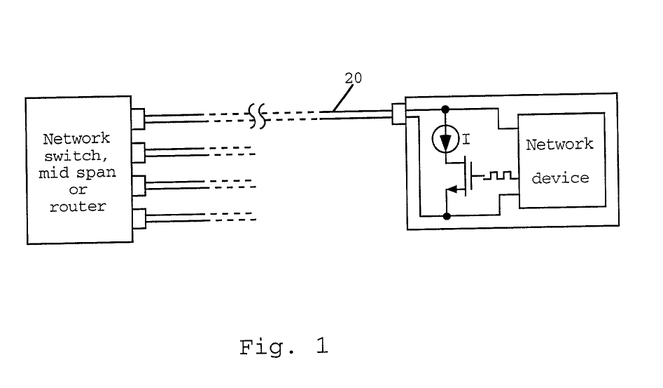

An exemplary embodiment of the present invention may be seen in FIG. 1. As may be seen therein, a plurality of network devices, one being shown in detail in FIG. 1, are connected to a network switch, router, or mid span through lines 20. These lines may be simply a pair of lines, or a greater number of lines depending on the communication standard being used. Depending on the network device, all lines may be used for signal transmission with the network device being separately powered. For other network devices on the same network, it may be desired to power the network devices from certain lines of the network. Powering certain network lines when the attached device is attempting to use the same lines for signaling will interfere with the communication, and may do permanent damage to the network device depending on the voltage of the power supplied over the network lines. On the other hand, not powering a network device depending on the presence of such power will render the network device unusable. Consequently, some method of detecting the attachment and continued presence of a network device requiring power, and perhaps even the identification of the specific device to determine its specific power requirements, is required.

One way this may be done is to provide a switch, router, or mid span that initially provides a low voltage between the applicable network lines and look for a specific current, indicating the presence of the expected load on the lines. Once the presence of the network device needing power is detected, then the network switch, router, or mid span will apply the applicable power to the network lines to power the network device. Thereafter, the impedance of the load may change once the normal power voltage is applied to the network device, and may vary depending on whether the network device is operating or not. Consequently continually identifying the device by the magnitude of the load it represents may not be feasible, even though its continued connection may be detected by noting the presence on the lines of at least a minimum load current drawn by the network device.

As an alternative, the exemplary embodiment of FIG. 1 illustrates a representative network device including a current source I and transistor Q1 in series across the lines that may be used for powering the network device. The transistor in this embodiment is driven with a square wave at a frequency fₛ, typically a relatively low frequency, so that the load presented by the network device is modulated by the current I of the current source, independent of the actual load presented by the network device, which current modulation is easily detected by the network switch, router, or mid span to not only continually indicate that the network device is still connected, but to also continually identify the type of device connected.

The square wave modulation of the load current as shown in FIG. 1 is exemplary only. By way of example, the modulation current waveform may by rounded (filtered) to suppress harmonics, may be of a duty cycle differing from 50%, within one of a plurality of duty cycle ranges for additional signaling capability, within one of a plurality of current modulation ranges and/or of one of a plurality of modulation frequencies selected for signaling purposes. Similarly, the modulation of the current may be created by various other means, such as a modulated voltage source in series with a resistor across the respective network connections, or even simply a modulated resistance across the network connections. These later modulation techniques are not preferred, however, as they present a resistive load on the network lines that will draw more power when full power is applied to the network line powered device.

An example of the application of this method is for Internet appliances such as Internet phones (IP phones), Wireless Access Nodes, Web Cameras, etc. These devices shall be referred hereafter as Network Power Devices. These Network Power Devices are connected to an Internet hub, switch, mid span or router. The Internet switch, mid span or router need to differentiate a Network Power Device from other appliances in order to perform proper power management of the Network Power Device. The Network Power Device gets powered from the RJ45 cable connected to the switch. Other appliances that could instead be connected to the cable such as computers do not draw power from the cable, but rather may use the same lines as ordinary signal lines. Therefore it is important for the switch, mid span or router to differentiate the Network Power Device from other appliances such as computers. When the Network Power Device gets plugged in or unplugged, it is required for the switch, mid span, or router to detect such connection to power the Network Power Device, and to remove power when the Network Power Device is disconnected before the same lines may be connected to another device intolerant of the Network Power Device power voltages. Therefore it is required for the Network Power Device to send a “presence signal” to the switch, both initially when plugged in to activate Network Power Device power on the lines, and continuously after being powered so long as the Network Power Device remains connected. Using the method described herein, an integrated circuit in the Network Power Device would have a supply current which is modulated by some modulation scheme such as amplitude or pulse modulation, so that an integrated circuit residing in the router or switch will detect the modulating supply current of the integrated circuit residing in the Network Power Device. When the modulating supply current is not present, then this would be detected as the Network Power Device not being present.

As an example, suppose the supply current of a first integrated circuit is Idc=10 mA. A second integrated circuit supplying power to this integrated circuit may detect the presence of the first integrated circuit, if the 10 mA supply current of the first integrated circuit was modulated as, say, 8 mA to 12 mA, or 10 mA to 12 mA at a fixed frequency. Therefore, if the second integrated circuit looks for an alternating (or pulsating) load current and does not find it, then it must be concluded that the first integrated circuit is not connected as a load to the second integrated circuit. If, however, the second integrated circuit senses an alternating load current of 8 mA to 12 mA, or 10 mA to 12 mA, then it can be concluded that the first integrated circuit is indeed connected as a load.

Thus one can code different integrated circuits to have different characteristics of the modulated supply current components, and then detect not just their connection but also the type or class of integrated circuit that is connected. Such information could be detected using an initial and momentary low voltage and/or current from the router or switch that any device that may be connected could tolerate, and then used, by way of example, to control the final power supply to the identified device, and/or to configure hardware and/or software to accommodate the operational and/or communication requirements of the device detected as being connected.

Also as noted, the modulation scheme need not be limited to any particular modulation scheme. Note that any modulation scheme such as pulse, frequency and/or amplitude modulation could be used. Also, the modulation current may flow through any of the pins of the integrated circuit, such as supply pins, ground pin, or any other input or output pins, provided the presence of the modulated current does not interfere with the normal function (typically but not necessarily signal communication) of the associated line.

While the present invention is intended primarily for the continued detection of the connection of a network power device to a network, it may also be used for the detection of the initial connection of such a device to a network, typically by first applying a low power signal such as a low voltage to the respective network lines, modulating the resulting line current in the network power device and looking for the line current modulation signature identifying the presence and nature of the device so connected at a remote location. The modulation for initial connection detection may be the same as or different from the modulation then used to sense the continued connection of the network power device. By way of example, the current modulation for initial detection before power is applied may be substantially lower than after power is applied to what is then an already identified present network power device, as before the power is applied, the device itself is not doing anything to vary the line current at any frequency.

Alternatively, other methods of detecting the initial detection of the connection of a device to the network may be used, such as, by way of example, the placement of an identifying resistor across the network lines connected to the power terminals of the network power device and detecting the presence of the resistor by placing a low power signal on the line such as a low voltage on the line and detecting a predetermined current, or placing a low voltage current source on the line and looking for a predetermined lower voltage corresponding to the presence of the resistor.

The present invention is particularly suited to communication of both data and power on power lines, and low impedance lines in general wherein a low impedance power source on lines at one location on a network will prevent or substantially inhibit meaningful modulation of the voltage of the same lines at another location on the network. It is also suitable for use wherein a number of lines or ports such as in a router are powered from a common DC power source, where successful voltage modulation of certain power lines would couple to other power lines through the common power supply. Also, while the present invention is particularly suited to use on devices powered through an RJ45 cable, it is not so limited.

Thus while certain exemplary embodiments of the present invention have been described in detail and shown in the accompanying drawings, it is to be understood that such embodiments are merely illustrative of and not restrictive on the broad invention, and that this invention is not to be limited to the specific arrangements, constructions and methods shown and described, but instead is to be defined by the full scope of the following claims, since various other modifications will occur to those of ordinary skill in the art.

What is claimed is:

1. A method of determining the continued presence of a particular network power device on a network comprising:
supplying current to the network power device over network lines from a first remote location;
modulating at the network power device and in a predetermined manner, the current supplied from the remote location;
detecting the modulated current at a second location remote to the network power device; and,
terminating the supply of current to the network power device upon failure to continue to detect the modulated current at the second location remote to the network power device.

2. The method of claim 1 wherein the modulated current is detected at a network switch.

3. The method of claim 1 wherein the modulated current is detected at a network router.

4. The method of claim 1 wherein the modulated current is detected at a network mid span.

5. The method of claim 1 wherein the current supplied to the network power device is modulated by switching a current source across network lines at a predetermined frequency.

6. The method of claim 1 wherein the network lines are RJ45 lines.

7. The method of claim 1 further comprised of determining the initial connection of the network power device to the network lines.

8. The method of claim 7 wherein the initial connection is determined by placing a low power signal on the network lines and detecting the present of a predetermined resistor on the lines at the network power device.

9. The method of claim 7 wherein the initial connection is determined by placing a low power signal on the network lines, modulating a current at the network power device from the low power signal, and detecting the modulated current at the second location remote to the network power device.

10. The method of claim 9 wherein the modulation of the current at the network power device for detecting initial connection of the network power device to the network is the same as the modulation of the current at the network power device for detecting the continued connection of the network power device to the network.

11. The method of claim 9 wherein the modulation of the current at the network power device for detecting initial connection of the network power device to the network is different than the modulation of the current at the network power device for detecting the continued connection of the network power device to the network.

12. The method of claim 11 wherein the modulation of the current at the network power device for detecting initial connection of the network power device to the network is less than the modulation of the current at the network power device for detecting the continued connection of the network power device to the network.

13. A method of determining the continued presence of a particular network power device on a network comprising:
supplying current to the network power device over RJ45 network lines from a first remote location;
modulating at the network power device and in a predetermined manner, the current supplied from the remote location;
detecting the modulated current at a second location remote to the network power device; and,
terminating the supply of current to the network power device upon failure to continue to detect the modulated current at the second location remote to the network power device.

14. The method of claim 13 wherein the modulated current is detected at a network switch.

15. The method of claim 13 wherein the modulated current is detected at a network router.

16. The method of claim 13 wherein the modulated current is detected at a network mid span.

17. The method of claim 13 wherein the current supplied to the network power device is modulated by switching a current source across network lines at a predetermined frequency.

18. The method of claim 13 further comprised of determining the initial connection of the network power device to the network lines.

19. The method of claim 18 wherein the initial connection is determined by placing a low power signal on the network lines and detecting the present of a predetermined resistor on the lines at the network power device.

20. The method of claim 18 wherein the initial connection is determined by placing a low power signal on the network lines, modulating a current at the network power device from the low power signal, and detecting the modulated current at the second location remote to the network power device.

21. The method of claim 20 wherein the modulation of the current at the network power device for detecting initial connection of the network power device to the network is the same as the modulation of the current at the network power device for detecting the continued connection of the network power device to the network.

22. The method of claim 20 wherein the modulation of the current at the network power device for detecting initial connection of the network power device to the network is different than the modulation of the current at the network power device for detecting the continued connection of the network power device to the network.

23. The method of claim 22 wherein the modulation of the current at the network power device for detecting initial connection of the network power device to the network is less than the modulation of the current at the network power device for detecting the continued connection of the network power device to the network.

24. A method of determining the continued connection of a particular first integrated circuit connected to and powered by a second integrated circuit comprising:
supplying current from the second integrated circuit to the first integrated circuit over power lines there between to power the first integrated circuit;
modulating in the first integrated circuit and in a predetermined manner, the current supplied from the second integrated circuit; and,
detecting the modulated current in the second integrated circuit.

25. The method of claim 24 wherein the current supplied to the first integrated circuit is modulated by switching a current source across the power lines at a predetermined frequency.

26. The method of claim 24 further comprised of terminating in the second integrated circuit the supply of current to the power lines upon failure to continue to detect the modulated current in the second integrated circuit.

27. The method of claim 26 further comprised of determining, in the second integrated circuit, the initial connection of the first integrated circuit to the power lines.

28. The method of claim 27 wherein the initial connection is determined by placing, in the second integrated circuit, a low power signal on the power lines and detecting the presence of a predetermined resistor in the first integrated circuit.

29. The method of claim 27 wherein the initial connection is determined by placing, in the second integrated circuit, a low power signal on the power lines, modulating a current in the first integrated circuit from the low power signal, and detecting the modulated current in the second integrated circuit.

30. The method of claim 29 wherein the modulation of the current in the first integrated circuit for detecting initial connection of the first integrated circuit is the same as the modulation of the current in the first integrated circuit for detecting the continued connection of the first integrated circuit.

31. The method of claim 29 wherein the modulation of the current in the first integrated circuit for detecting initial connection of the first integrated circuit is different from the modulation of the current in the first integrated circuit for detecting the continued connection of the first integrated circuit.
